(19) United States
(12) Patent Application Publication
(10) Pub. No.: US 2019/0225123 A1
(43) Pub. Date: Jul. 25, 2019

(54) SEAT HAVING A BACKREST AND A HEAD RESTRAINT

(71) Applicant: Adient Luxembourg Holding S.à r.l., Luxembourg (LU)

(72) Inventor: Ulrich KARTHAUS, Remscheid (DE)

(21) Appl. No.: 16/338,192

(22) PCT Filed: Sep. 22, 2017
(86) PCT No.: PCT/EP2017/073987

§ 371 Date: Mar. 29, 2019

(30) Foreign Application Priority Data
Sep. 30, 2016 (DE) 10 2016 219 012.1

(51) Int. Cl. B60N 2/30; B60N 2/832; B60N 2/829; B60N 2/02

(52) U.S. Cl. CPC B60N 2/3009; B60N 2/832; B60N 2002/0236; B60N 2/0232; B60N 2/829

(57) ABSTRACT

A seat (1, 1′, 1″) having a seat part (2), a backrest (3, 3′, 3″) and a head restraint (4). The backrest (3, 3′, 3″) is pivotable between a seat position (Si) and a forwardly folded position (S2) by a backrest adjustment unit (8), and the head restraint (4) is adjustable between a use position (K1) and a non-use position (K2) by the backrest adjustment unit (8) firstly opening a rotary fitting (32) or a latching fitting (26) of the backrest (3, 3′, 3″) and secondly adjusting the backrest (3, 3′, 3″) between the seat position (Si) and the forwardly folded position (S2), and, during pivoting of the backrest (3, 3′, 3″) from the seat position (S1) into the forwardly folded position (S2), the head restraint (4) is adjusted by an adjustment drive (9) into the non-use position (K2).

### CROSS REFERENCE TO RELATED APPLICATIONS

This application is a United States National Phase Application of International Application PCT/EP2017/073987 filed Sep. 22, 2017, and claims the benefit of priority under 35 U.S.C. § 119 of German Application DE 10 2016 219 012.1, filed Sep. 30, 2016, the entire contents of which are incorporated herein by reference.

### TECHNICAL FIELD

The invention relates to a seat, in particular a vehicle seat, having a seat part, a backrest and a headrest.

### TECHNICAL BACKGROUND

Seats are known from the prior art which have an adjustable-height headrest, the headrest having a head part and a carrier for the head part, which carrier is guided displaceably in the backrest, and it being possible for said headrest to be adjusted between a use position and a non-use position.

In order to enlarge a load volume or a load floor in a vehicle, it is additionally known to fold over the backrest of a second or third seat row. This can take place manually or by way of a remote control, in the case of which latching fittings of the backrest are unlocked electrically and the backrest is folded downward in a spring-assisted manner. The backrest is usually erected by hand.

WO 99/41104 A1 discloses a vehicle seat having a seat part, a backrest and a headrest, it being possible for the backrest to be pivoted between a seat position and a folded-forward position, and it being possible for the headrest to be adjusted between a use position and a non-use position, and, in the case of pivoting of the backrest from the seat position into the folded-forward position, the headrest being set into the non-use position by means of an adjusting drive and, in the case of pivoting back of the backrest out of the folded-forward position into the seat position, the headrest being set into the use position by means of the adjusting drive. Vehicle seats of this type are additionally known from DE 10 2007 022 623 A1, DE 198 32 902 A1, DE 102 47 682 A1, US 2011/0101738 A1 and GB 2 318 285 A.

### SUMMARY

It is an object of the present invention to specify an improved seat having a simplified adjusting mechanism for folding away the backrest.

According to the invention, the object is achieved by way of a seat, in particular a vehicle seat, which comprises a seat part, a backrest and a headrest, it being possible for the backrest to be pivoted between a seat position and a folded-forward position by means of a backrest adjusting unit, and it being possible for the headrest to be adjusted in the seat position between a use position and a non-use position, by the backrest adjusting unit firstly opening a rotary fitting or a latching fitting of the backrest, and secondly adjusting the backrest (3, 3′, 3″) between the seat position (S1) and the folded-forward position (S2), and, in the case of pivoting of the backrest from the seat position into the folded-forward position, the headrest being set into the non-use position by means of an adjusting drive and, in the case of pivoting back of the backrest out of the folded-forward position into the seat position, the headrest being set into the use position by means of the adjusting drive, and the adjusting drive being coupled to the backrest adjusting unit and being released in the case of unlocking of the backrest adjusting unit.

The advantages which are achieved by way of the invention consist, in particular, in that the adjusting drive for the headrest is not loaded mechanically in the case of an accident. In addition, the simultaneous, in particular positively guided lowering of the headrest into the non-use position during the folding forward of the backrest into the folded-forward position avoids or at least considerably reduces the headrest coming into contact with the backrest of a front seat or being jammed there. Moreover, in addition to an increase in a load floor area, the invention also makes a largely closed and planar load floor possible.

In one embodiment, the adjusting drive for the headrest is a spring drive. For example, the spring drive is a compression spring or a tension spring.

In the case of a configuration of the spring drive as a tension spring, the latter is tensioned during folding away of the backrest, with the result that said spring drive automatically sets the headrest, in particular the head part, from the non-use position into the use position in the case of the erecting of the backrest.

In the case of a configuration of the spring drive as a compression spring, the latter is compressed and therefore tensioned in the case of the folding away of the backrest, with the result that said compression spring automatically sets, in particular presses, the headrest, in particular the head part, from the non-use position into the use position as a consequence of the relaxation during the erecting of the backrest. Here, the spring drive assists the backrest drive in the case of the erecting of the backrest into the seat position. As a result, the backrest drive can be designed with a lower power output or a higher speed.

The backrest adjusting unit can be operated electrically or manually, for example. In one possible embodiment, the backrest adjusting unit is configured as an electric geared motor. As an alternative, in one simple embodiment, the backrest adjusting unit can be configured as a coupler mechanism.

At least one cable is provided for coupling the adjusting drive and the headrest to the backrest adjusting unit. Here, the cable can be fastened on the headrest side to a headrest receptacle and on the backrest side to the backrest adjusting unit. In addition to the cable, the adjusting drive, in particular the spring drive, such as the tension or compression spring for the headrest adjustment, can be fastened on the headrest side to the headrest receptacle and on the backrest side to the backrest adjusting unit.

Moreover, the backrest comprises at least one retaining region for retaining the headrest in a use position and a loose region for receiving the headrest in a non-use position. Here, the retaining region and/or the loose region and, in a manner corresponding to them, the headrest receptacle can be configured with respect to one another in such a way that the headrest can be set and/or locked into/in one of the plurality of use positions and/or into/in one of a plurality of non-use positions.

In the case of the folding back of the backrest into the seat position and therefore the simultaneous adjusting of the headrest into the use position or into a region (also called comfort range) with a plurality of use positions, the headrest receptacle can be locked in a positively locking and/or non-positive manner, in particular is held in a clamping manner, with the one end of the cable which is fastened to it and the one end of the adjusting drive in the retaining region.

The advantages which are achieved by way of the invention consist, in particular, in that, in particular in the case of a remote controlled folding away or erecting of the backrest, the headrest can be set in a positively controlled manner from the use position into the non-use position or conversely from the non-use position into the use position automatically and at the same time as the folding away or erecting of the backrest. In other words, here, the backrest adjusting unit firstly opens a rotary fitting or latching fitting of the backrest, and secondly adjusts the backrest, the headrest being adjusted at the same time.

Since the backrest adjusting unit does not have to absorb any crash loading and as a result of the utilization of the, in particular, spring-assisted adjusting drive of the headrest, there is a particularly simple and inexpensive overall design for an adjusting mechanism for folding away or erecting the backrest.

Here, the actual function of a latching fitting or rotary fitting is not affected by way of the backrest adjusting unit. The two fitting systems can still be operated manually for a comfort setting, and absorb the crash loading. A latching fitting is known, for example, from DE 10 2005 046 806 B3. An un-lockable rotary fitting is known, for example, from WO 2014/128297 A1.

By way of the backrest adjusting unit, the fittings are first of all unlocked in an analogous manner with respect to a manual actuation, and the backrest is then adjusted electrically via a toothed segment and the pinion.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a diagrammatic perspective view of a vehicle interior compartment with a plurality of seats having in each case one adjustable backrest and one adjustable headrest;

FIG. 2 is a diagrammatic perspective view of a seat having a backrest in a seat position with an extended headrest;

FIG. 3 is a diagrammatic perspective view of a seat having a backrest in a folded-forward position with a retracted headrest,

FIG. 4A is a diagrammatic view showing a part of a sequence of the retraction and extension of a headrest;

FIG. 4B is a diagrammatic view showing a part of a sequence of the retraction and extension of a headrest;

FIG. 4C is a diagrammatic view showing a part of a sequence of the retraction and extension of a headrest;

FIG. 4D is a diagrammatic view showing a part of a sequence of the retraction and extension of a headrest;

FIG. 5 is a diagrammatic perspective view of an adjusting drive for the headrest;

FIG. 6 is a diagrammatic perspective view of a backrest adjusting unit for the backrest;

FIG. 7 is a diagrammatic perspective view of an alternative adjusting drive for the headrest;

FIG. 8 is a diagrammatic perspective view of a backrest adjusting unit for the backrest;

FIG. 9 is a diagrammatic exploded view of a further alternative of an adjusting drive for the headrest and a backrest adjusting unit for the backrest having a latching fitting;

FIG. 10 is a diagrammatic exploded view of a further alternative of an adjusting device for the headrest;

FIG. 11 is a diagrammatic exploded view of a further alternative of a backrest adjusting unit for the backrest having a rotary fitting;

FIG. 12 is a diagrammatic exploded view of a further alternative of a backrest adjusting unit for the backrest having a rotary fitting;

FIG. 13 is a diagrammatic exploded view of a further alternative of an adjusting drive for the headrest;

FIG. 14 is a diagrammatic exploded view of a further alternative of a backrest adjusting unit for the backrest having a coupler mechanism;

FIG. 15 is a diagrammatic exploded view of a further alternative of an adjusting drive for the headrest; and

FIG. 16 is a diagrammatic exploded view of a further alternative of a backrest adjusting unit for the backrest having an alternative coupler mechanism.

### DESCRIPTION OF PREFERRED EMBODIMENTS

Referring to the drawings, parts which correspond to one another are provided with the same designations in all figures.

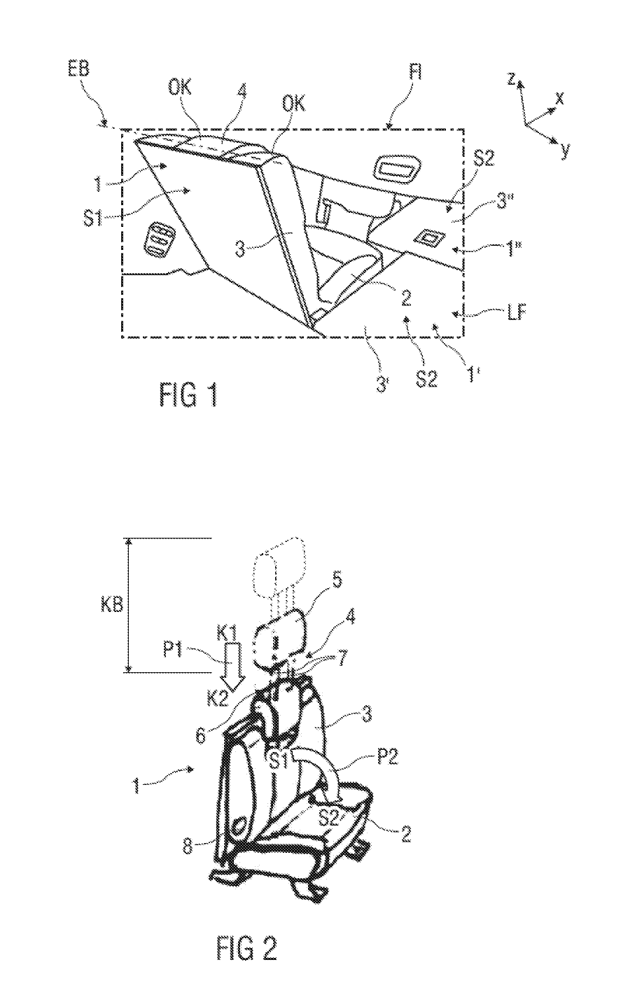

FIG. 1 diagrammatically shows a perspective illustration of a vehicle interior compartment FI with a seat 1 having a backrest 3 which can be adjusted relative to a seat part 2, and having an adjustable headrest 4.

The seat 1 which is shown diagrammatically in FIG. 1 is, in particular, a vehicle seat, and will be described in the following text with the use of three spatial directions which run perpendicularly with respect to one another. In the case of a vehicle seat which is installed in the vehicle, a longitudinal direction x runs largely horizontally and preferably parallel to a vehicle longitudinal direction which corresponds to the usual driving direction of the vehicle. A transverse direction y which runs perpendicularly with respect to the longitudinal direction x is likewise oriented horizontally in the vehicle and runs parallel to a vehicle transverse direction. A vertical direction z runs perpendicularly with respect to the longitudinal direction x and perpendicularly with respect to the transverse direction y. In the case of a vehicle seat which is installed in the vehicle, the vertical direction z runs parallel to the vehicle vertical axis.

The positional specifications and directional specifications which are used, such as front, rear, top and bottom, relate to a viewing direction of an occupant who is seated in the vehicle seat in the normal seat position, the vehicle seat being installed in the vehicle and being oriented in a use or seat position S1 which is suitable for passenger transportation with an upright backrest 2 and, as is customary, in the driving direction. The seat 1 according to the invention can also be installed in a different orientation, however, for example transversely with respect to the driving direction.

FIG. 1 shows three seats 1, 1′, 1″ in the vehicle interior compartment FI of the vehicle, the backrest 3 of one of the seats 1 standing upright in a use or seat position S1. The other backrests 3′, 3″ of adjoining seats 1′, 1″ are shown in a folded-forward position S2. In order to achieve a closed load floor after folding away all the backrests 3 to 3′ into the folded-forward position S2, the headrest 4 of the respective seat 1 to 1″ has to be adjusted. To this end, in particular, the respective headrest 4 has to be retracted completely relative to the backrest 3 in such a way that the upper edges OK of the headrest 4 and the backrest 3 lie largely in one plane EB.

As a result, for example, the backrests 3′ and 3″ of adjoining seats 1′ and 1″, respectively, can form a closed load floor LF in the folded-away state.

To this end, the height of the headrest 4 can be adjusted by hand or by way of mechanical decoupling. Here, the headrest 4 can fall, in particular as a result of its weight, into a non-use position K2 (as shown in FIGS. 2 and 3) and can therefore be set.

FIGS. 2 and 3 show the seat 1 in further perspective illustrations, the backrest 3 and the headrest 4 being positioned differently relative to one another.

The headrest 4 comprises at least one head part 5 and a carrier 6. The head part 5 is, in particular, a padded part, the front side of which forms a bearing face for a head of a user who is seated on the seat 1.

The carrier 6 is retained in the head part 5 and protrudes downward out of the head part 5 in the direction of the backrest 3. The carrier 6 is formed, in particular, from two rods 7 or a U-shaped bracket, the two ends of which protrude out of the head part 5.

In order to adapt the height of the head part 5, for example to users of different height of the seat 1, the headrest 4 is adjustable, in particular can be adjusted in terms of the height from a use position K1 into another desired use position within what is known as a comfort range KB. The head part 5 can be adjusted individually in terms of height within the comfort range KB. For the case where the headrest 4 also has an inclination adjuster, the inclination of the head part 5 can additionally be adjusted.

Moreover, the headrest 4, in particular the head part 5, can be set into a non-use position K2 in accordance with arrow P1 or in the opposite direction.

It is provided that the backrest 3 can be pivoted during operation by means of a backrest adjusting unit 8 between the seat position S1 and the folded-forward position S2 in accordance with arrow P2 in order to achieve an increase in the load volume.

The backrest adjusting unit 8 is, for example, an inclination adjuster with a latching device, it being possible, after release of the latching device, for the backrest 3 to be folded or pivoted manually or electrically out of a largely upright use or seat position S1 into the folded-forward position S2 (also called loading or floor position) which runs in an approximately horizontal or level manner.

The load volume of the vehicle is increased by way of the pivoting of the backrest 3 of a seat or a seat bench in a second or third seat row in a vehicle into the folded-forward position S2.

Here, the unlocking of the latching device of the backrest adjusting unit 8 can take place manually or electrically. Here, the pivoting or folding away of the backrest 3 can initially be assisted, in particular can be damped, by means of a spring device, and can be assisted by way of the dead weight of the backrest 3 during the further pivoting course.

Here, the head part 5 can be pivoted, in particular in the seat position S1 of the backrest 3, between the use position K1 and the non-use position K2 or conversely in a manner which is dependent on the position of the backrest 3.

In order to assist the folding away or pivoting of the backrest 3 into the folded-forward position S2 and to achieve a closed load floor, the headrest 4, in particular its head part 5, is set into the non-use position K2 in the case of pivoting of the backrest 3 from the seat position S1 into the folded-forward position S2, as shown in FIG. 2 by way of the arrows 1 and 2. FIG. 3 shows the seat 1 with the folded-forward backrest 3 and the retracted headrest 4.

Here, the retraction of the head part 5 of the headrest 4 relative to the backrest 3 is positively guided during the folding away of the backrest 3 into the folded-forward position S2.

In the case of pivoting back of the backrest 3 out of the folded-forward position S2 into the seat position S1 in accordance with arrow 3, the headrest 4, in particular its head part 5, is then set into the use position K1. That is to say, for the use of the seat 1, the backrest 1 is erected again manually, in particular by means of a coupling mechanism, or electrically, in particular by means of an electric geared motor, and the headrest 4, in particular the head part 5, is set into the use position K1 again in a positively guided manner.

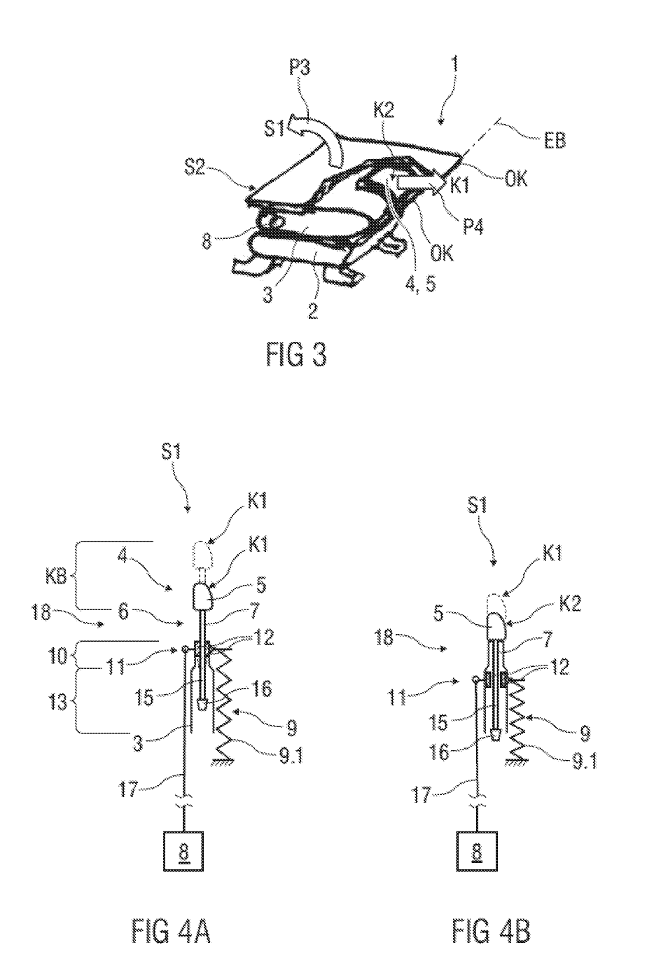

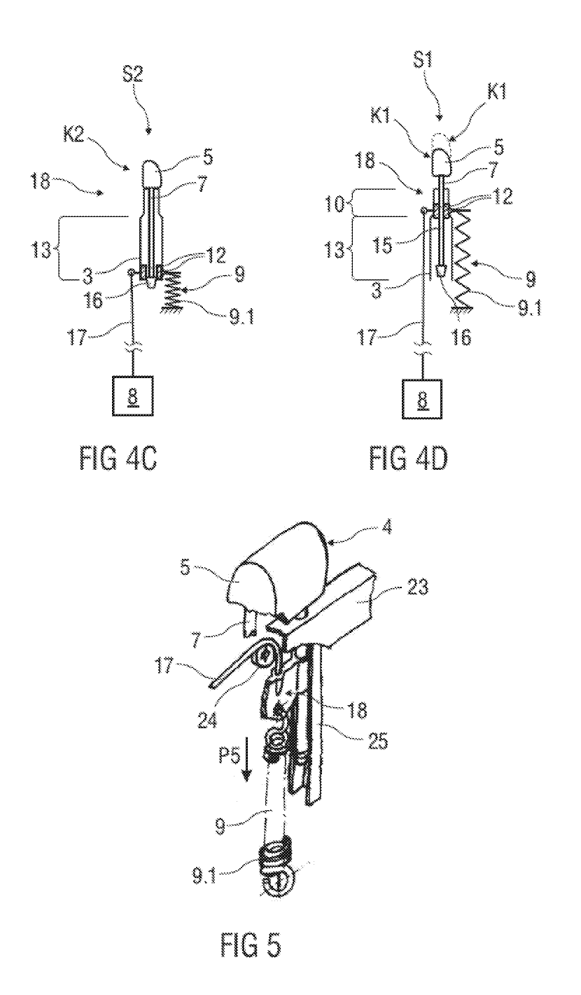

In order to adjust the head part 5 of the headrest 4, said headrest 4 comprises an adjusting drive 9. FIG. 4 shows one possible embodiment of the adjusting drive 9.

In order to adjust the headrest 4, in particular in an automatic or positively guided manner, in the case of an adjustment of the backrest 3 between a seat position S1 and the folded-forward position S2 or in the opposite direction, the adjusting drive 9 is coupled to the backrest adjusting unit 8, it being possible for the adjusting drive 9 of the headrest 4 to be released in the case of unlocking of the backrest adjusting unit 8 and folding of the backrest 3 forward into the folded-forward position S2.

The adjusting drive 9 is configured, for example, as a spring drive 9.1. The adjusting drive 9 is coupled to the backrest adjusting unit 8 in such a way that the spring drive 9.1 is released in the case of unlocking of the backrest adjusting unit 8.

As the sequence in accordance with FIGS. 4A to 4D shows, the headrest 4 is set in the seat position S1 of the backrest 3 into one of the use positions K1 in the comfort range KB.

For improved clarity of the positively guided positioning of the headrest 4 in the different positions of the backrest 3, FIGS. 4A to 4D show the backrest 3 in each case in a perpendicular manner, the backrest 3 being situated in a seat position S1 in FIGS. 4A, 4B and 4C, and in a folded-forward position S2 in FIG. 4D.

In accordance with FIG. 4A, the headrest 4 can be set individually in the comfort range KB into one of the different use positions K1.

Here, the backrest 3 comprises a headrest receptacle 18 with a retaining region 10, within which the headrest 4 can be set into and retained in different use positions K1. To this end, the headrest receptacle 18 comprises a retaining and locking device 11. The retaining and locking device 11 is, for example, a conventional latching or clamping device. The retaining and locking device 11 comprises, for example, two clamping jaws 12, by means of which the rods 7 are retained in the retaining region 10 in a non-positive or frictionally locking manner.

The retaining region 10 of the backrest 3 is adjoined by a loose region 13, into which the retaining and locking device 11 can be set if the backrest 3 is set into the folded-forward position S2 or the backrest 3 is situated in said folded-forward position S2.

The retaining region 10 and the loose region 13 form the headrest receptacle 18 and are formed, for example, in a load-bearing structure of the backrest 3 by way of correspondingly shaped profile elements, for example hollow profile elements. Here, the retaining region 10 has smaller dimensions in comparison with the loose region 13. In particular, the retaining region 10 has dimensions which are such that the rods 7 are retained in the retaining region 10 in a positively locking and/or non-positive manner, in particular in a frictionally locking manner, for example in a clamping manner.

The loose region 13 has dimensions which are such that the retaining rods 7 of the headrest 4 are released, with the result that, if the headrest 4 is not retained in the retaining region 10, the headrest 4 falls into the non-use position K2 on account of the dead weight of the head part 5.

FIG. 4B shows the headrest 4 during the folding away of the backrest 3 into the folded-forward position S2. In the case of the folding forward of the backrest 3, the headrest 4 and therefore the rods 7 are set together with the retaining and locking device 11 in the retaining region 10 in the direction of the loose region 13 on account of the coupling of the adjusting drive 9 to the backrest adjusting unit 8. When the retaining region 10 is left and therefore when the loose region 13 is reached, the retaining and locking device 11 opens automatically, with the result that the headrest 4 falls into the non-use position K2 on account of its weight.

When the backrest 3 reaches the folded-forward position S2, the headrest 4 is retained captively by the retaining and locking device 11, as shown in FIG. 4C. To this end, the headrest 4 comprises a stop body 16 at the free end 15 of the rods 7.

In the case of the erecting of the backrest 3 out of the position S2 into the seat position S1, the headrest 4 is automatically set by means of the adjusting drive 9 out of the loose region 13 into the retaining region 10 in order to set a first use position K1 in the comfort range KB. Subsequently, the headrest 4 can be set into another use position K1 within the comfort range KB.

In the embodiment, the adjusting drive 9 for the headrest 4 is a spring drive 9.1. For example, the spring drive 9.1 is a compression spring or a tension spring.

In the case of a configuration of the spring drive 9.1 as a tension spring, said tension spring is tensioned in the case of folding away of the backrest 3, with the result that said spring drive 9.1 automatically sets the headrest 4 out of the non-use position K2 into the first use position K1 in the case of the erecting of the backrest 3.

In the case of an alternative configuration of the spring drive 9.1 as a compression spring, said compression spring is compressed and therefore tensioned in the case of folding away of the backrest 3, with the result that said compression spring automatically sets, in particular presses, the headrest 4 out of the non-use position K2 into the use position K1 as a consequence of the relaxation in the case of the erecting of the backrest 3. Here, the spring drive 9.1 can assist the backrest drive 8 in the case of the erecting of the backrest 3 into the seat position S1.

At least one cable 17, in particular a pull cable, is provided for coupling the adjusting drive 9 and the headrest 4 to the backrest adjusting unit 8. Here, the cable 17 can be fastened on the headrest side to the headrest receptacle 18 and on the backrest side to the backrest adjusting unit 8. In addition to the cable 17, the adjusting drive 9, in particular the spring drive 9.1, can be fastened on the headrest side to the headrest receptacle 18 and on the backrest side to the backrest adjusting unit 8 or to another suitable seat unit, for example to a seat part which is fixed to the vehicle body.

Moreover, the retaining region 10 and/or the loose region 13 can be configured in a corresponding manner with respect to the headrest receptacle 18 in such a way that the headrest 4 can be set and/or can be locked into/in one of a plurality of use positions K1 and/or into/in one of a plurality of non-use positions K2.

In the case of folding back of the backrest 3 into the seat position S1 and therefore the simultaneous adjusting of the headrest 4 into the use position K1 or into the comfort range KB with a plurality of use positions K1, the headrest receptacle 18 with the one end, fastened thereto, of the cable 17 and the one end of the adjusting drive 9 can be locked in a positively locking and/or non-positive manner, in particular is retained in a clamping manner, in the retaining region 10.

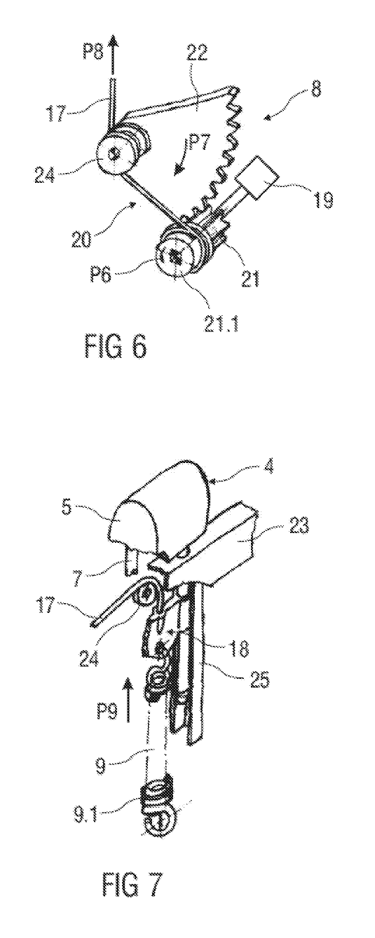

FIGS. 5 and 6 diagrammatically show a perspective illustration of an adjusting drive 9 having a tension spring as spring drive 9.1.

The adjusting drive 9 is coupled to the backrest adjusting unit 8 via the headrest receptacle 18 by means of the cable 17. The backrest adjusting unit 8 comprises, for example, an electric motor 19 with a gear unit 20, the pinion 21 of which engages into a toothed rocker 22 for coupling the backrest adjusting unit 8 to the adjusting drive 9. The cable 17 is retained on the pinion 21 on a cable drum 21.1.

Depending on the embodiment, the cable 17 can be guided both in the region of the headrest receptacle 18 and in the region of the gear unit 20 via a deflection roller 24.

In order to guide the headrest receptacle 18 in the backrest 3, the latter can comprise a headrest guide 25, for example guide tubes, guide sleeves or sliding bushes.

In the case of the unlocking of the backrest adjusting unit 8, the backrest 3 is folded forward by means of the motor 19. Here, the motor 19 drives the pinion 21 in accordance with arrow P6, as a result of which the cable 17 is actuated in accordance with arrow P7, the toothed rocker 22 is actuated in accordance with arrow P8, and the headrest 4 is set downward into the non-use position K2 in accordance with arrow P5.

Instead of a motorized adjustment of the backrest 3, the latter can also be adjusted manually, the motor 19 then being dispensed with and the manual drive (not shown in greater detail) being provided.

In the case of the erecting of the backrest 3, the headrest 4 is then set out of the non-use position K2 into a first use position K1 by way of coupling of the motor 18 via the gear unit 20 and the cable 17.

Here, the motor 19 is to be designed in such a way that the tensioning of the spring drive 9.1 also takes place in addition to the backrest weight. For this reason, the motor 19 has a relatively high drive output power.

FIG. 5 shows one possible embodiment for the securing of the headrest receptacle 18 in the backrest 3. To this end, a backrest frame 23 is provided, for example. The headrest guide 25 is also retained on the backrest frame 23, on which headrest guide 25 in turn the headrest receptacle 18 is retained in a movable manner and can be adjusted into different positions, for example into the use position K1 or the non-use position K2.

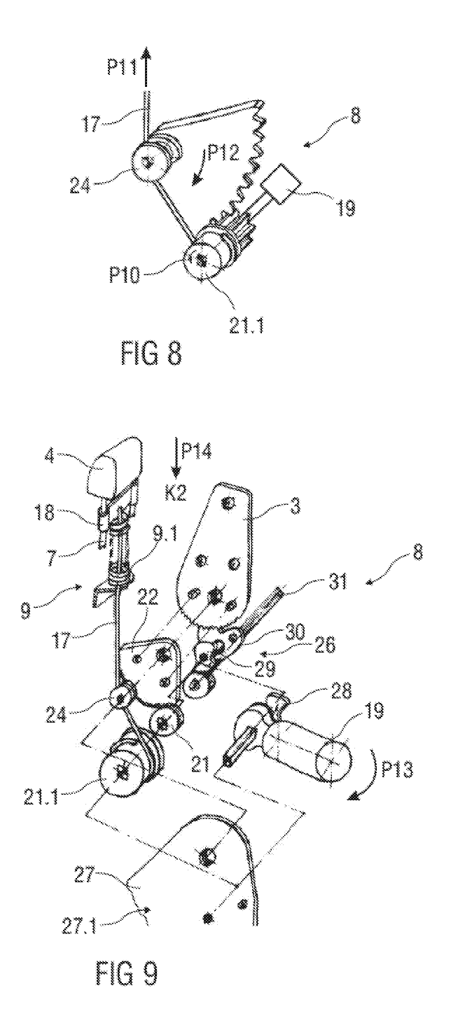

FIGS. 7 and 8 diagrammatically show a perspective illustration of an alternative adjusting drive 9 having a compression spring as spring drive 9.1. The construction of the drive mechanism and the coupling is the same as in the embodiment in accordance with FIGS. 5 and 6. Only the spring is different, which spring is a compression spring in the exemplary embodiment in accordance with FIGS. 7 and 8.

In the case of the lowering of the backrest 3, the headrest 4 is retracted by means of the motor 19 via the cable 17. Here, the spring drive 9.1 which is configured as a compression spring counteracts the weight of the backrest 3.

As a result, a uniform downward movement of the headrest 4 into the non-use position K2 is produced.

In the case of the erecting of the backrest 3, the spring drive 9.1 (the compression spring) moves the headrest 4 out of the non-use position K2 in accordance with arrow P9 into the first use position K1. Here, the motor 9 is assisted by the spring drive 9.1. As a result, the motor 9 can have a lower drive output power or can be operated at a higher speed.

The arrows P10 to P12 show the method of operation of the drive components for folding away the backrest 3 into the folded-forward position S2.

FIG. 9 diagrammatically shows an exploded illustration of a further alternative of a coupling of the adjusting drive 9 for the headrest 4 to a backrest adjusting unit 8 for the backrest 3. The cable 17 is guided through the adjusting drive 9, in particular through the spring drive 9.1.

Here, the backrest adjusting unit 8 has a latching fitting 26. The motor 19 is mounted on a carrier plate 27 of a seat part 27.1 of the seat 1 such that it can be rotated in accordance with arrow P13. The motor 9 has a drive cam 28 which is coupled mechanically to a switching cam 29 of the latching fitting 26.

During operation of the motor 19, a pivoting movement of the drive cam 28 takes place in accordance with arrow P13. By way of coupling of the drive cam 28 to the switching cam 29, the latter is actuated and actuates a transmission element 31. As a consequence, a latching element 30 of the latching fitting 26 and therefore the latching fitting 26 of the backrest 3 are opened. To this end, the switching cam 29 and the latching element 30 are mounted on a transmission element 31 and are fastened to the latter.

Further opening of the switching cam 29 is limited by a stop contour of the latching element 30, with the result that the motor 19 is stopped.

Subsequently, the pinion 21 is driven and, via the latter, the cable drum 21.1 is driven. As a consequence, the backrest 3 is pivoted via the rotating toothed rocker 22, and the headrest 4 is retracted in accordance with arrow P14 counter to the spring force of the compression spring of the spring drive 9.1 by means of the cable 17 which is retained on the pinion 21. When the folded-forward position S2 of the backrest 3 is reached, the headrest 4 is set into the non-use position K2.

In the case of the erecting of the backrest 3 out of the folded-forward position S2 into a seat position S1, the latching element 30 is first of all prevented from falling into the latching position via a control contour. When the seat position S1 is reached, the latching element 30 is released and can therefore latch and lock the backrest 3 in the set seat position S1.

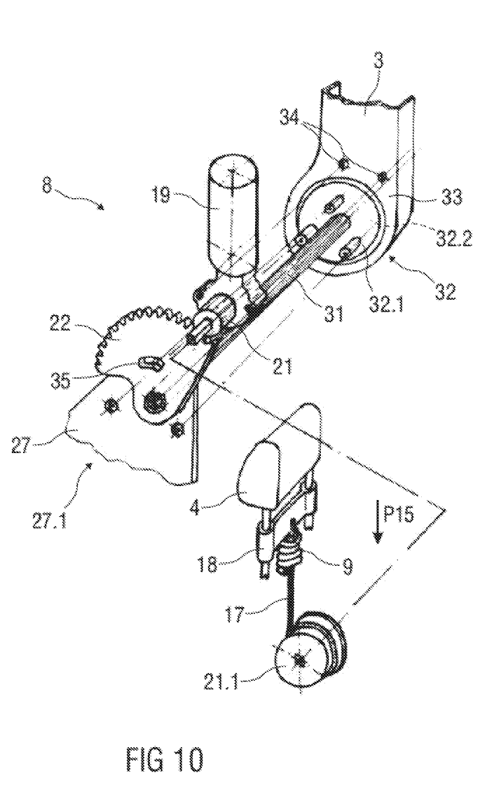

FIG. 10 diagrammatically shows an exploded illustration of a further alternative for a coupling of the adjusting drive 9 for the headrest 4 and the backrest adjusting unit 8 for the backrest 3 with a rotary fitting 32.

The motor 19 (in particular, a geared motor) is arranged on a side beam 33 of the backrest 3 and is fastened by means of fastening elements 34. The motor 19 drives the pinion 21 and, via the latter, the toothed rocker 22 which is mounted fixedly on the transmission element 31 so as to rotate with it. Here, the rotary fitting 32 is opened. The outer fitting part 32.1 of the latter is connected to the carrier plate 27 or a fitting part of the seat part 27.1 (also called the seat frame). The inner fitting part 32.2 of the rotary fitting 32 is connected to the side beam 33 of the backrest 3.

As soon as the rotational movement of the toothed rocker 22 is limited by the slot 35, the lowering or folding away of the backrest 3 takes place.

At the same time as the operation of the motor 19, the cable drum 21.1 is driven via the pinion 21, the backrest 3 is pivoted as a consequence via the rotating toothed rocker 22, and the headrest 4 is retracted in accordance with arrow P15 counter to the spring force of the compression spring of the spring drive 9.1 by means of the cable 17 which is retained on the pinion 21. When the folded-forward position S2 of the backrest 3 is reached, the headrest 4 is set into the non-use position K2.

Therefore, the lowering of the headrest 4 takes place in a positively guided manner and at the same time as the pivoting away or folding away of the backrest 3.

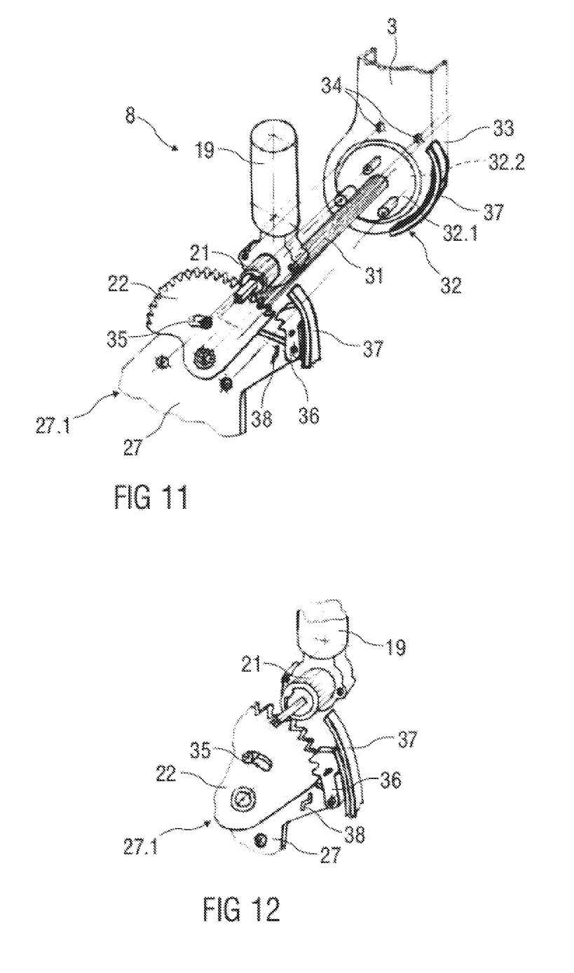

FIGS. 11 and 12 show one development of the embodiment in accordance with FIGS. 9 and 10.

Here, an additional ratchet lever 36 and a control contour 37 are provided on the backrest adjusting unit 8.

By way of the lowering of the backrest 3, the ratchet lever 36 is displaced via the control contour 37 into the toothed portion of the toothed rocker 22 and is held fixedly over the entire pivoting range of the backrest 3.

The control contour 37 is fastened rigidly to the side beam 33. The ratchet lever 36 is mounted rotatably on the carrier plate 27 or a fitting part of the seat part 27.1. The ratchet lever 36 is pressed outward in the direction of the control contour 37 by way of a leg spring 38.

In the case of the erecting of the backrest 3, the toothed rocker 22 is prevented from rotating back by way of the ratchet lever 36, with the result that the backrest 3 moves into the normal position or seat position S1 in the case of an open rotary fitting 32.

When the normal or seat position S1 is reached, the ratchet lever 36 and therefore the toothed rocker 22 are released again, and the rotary fitting 32 is locked.

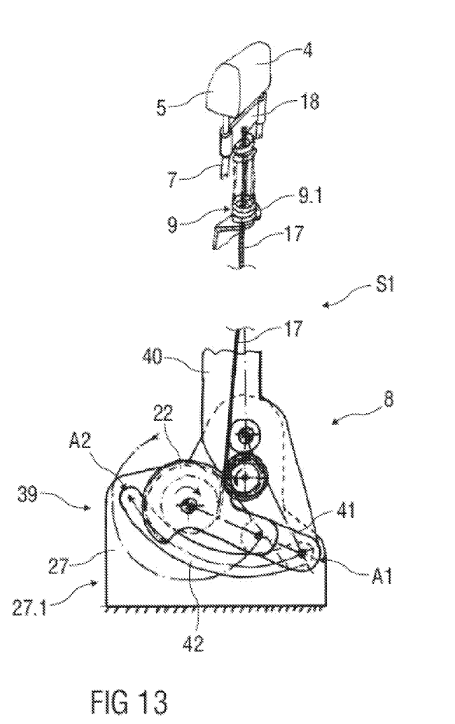

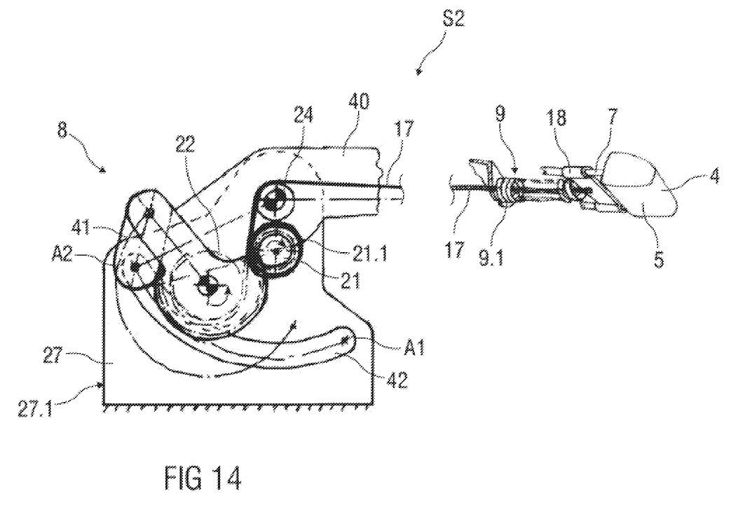

FIGS. 13 and 14 diagrammatically show an exploded illustration of a further embodiment of a coupling of the adjusting drive 9 for the headrest 4 to the backrest adjusting unit 8 for the backrest 3. Here, the backrest adjusting unit 8 comprises a coupler mechanism 39.

FIG. 13 shows the backrest 3 in the seat position S1. FIG. 14 shows the backrest 3 in the folded-forward position S2.

A backrest strut 40 of the backrest 3 is mounted rotatably on the carrier plate 27 of the seat part 27.1. The backrest strut 40 is driven by the toothed rocker 22 via a coupling link 41. As has already been described above, the toothed rocker 22 is driven by the pinion 21 which comprises the cable drum 21.1. As a consequence, in the case of the lowering of the backrest 3, the headrest 4 is retracted counter to the force of the compression spring of the spring drive 9.1 via the cable 17.

In the use position or seat position S1 of the backrest 3, the backrest strut 40 bears against a front stop A1. The coupling link 41 is positioned to a minimum extent beyond the top dead center, with the result that high forces can be absorbed without loading the drive and therefore the motor 19.

In the case of the erecting of the backrest 3, the spring drive 9.1 (in particular, the tensioned compression spring) assists the motor 19 of the backrest adjusting unit 8 via the cable 17 which exerts a torque on the pinion 21 via the deflection roller 24 and the cable drum 21.1. The drive output power can therefore be reduced, since part of the dead weight of the backrest 3 is compensated for by the spring drive 9.1. As an alternative, in the case of an identical drive output power of the motor 19, the speed can be increased.

The coupling link 41 is guided in a guide slot 42 of the carrier plate 27 of the seat part 27.1. Here, the maximum deflection movement of the coupling link 41 between the front stop A1 and a rear stop A2 is limited by way of the length of the guide slot 42. The guide slot 42 has an arcuate shape.

In the folded-forward position S2 of the backrest 3 (also called the flat floor or load floor position), the backrest strut 40 lies in the rear stop A2, with the result that no forces are transmitted to the motor 19 as a consequence of floor loading.

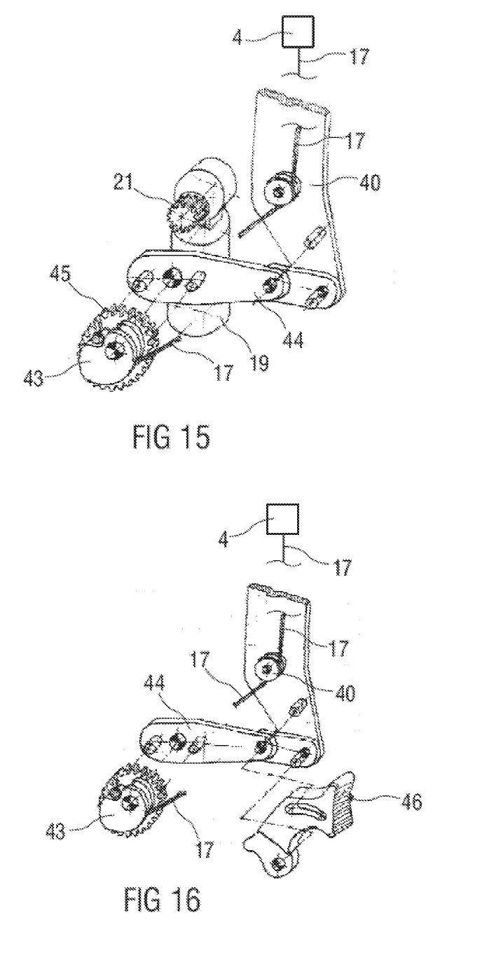

FIGS. 15 and 16 diagrammatically show an exploded illustration of a further electric or manual alternative for an actuation and coupling of the adjusting drive 9 for the headrest 4 at the same time as, and positively guided by way of, the backrest adjusting unit 8 for the backrest 3.

FIG. 15 shows an electric variant with a cable pulley 43 which is connected fixedly to a coupling linkage 44 so as to rotate with it. The cable pulley 43 has a toothing system 45, into which the pinion 21 of the motor 19 engages.

The cable pulley 43 is shaped eccentrically. As a result, in an analogous manner with respect to the above-described coupling of the backrest adjusting unit 8 to the adjusting drive 9 of the headrest, different torques and speeds can be realized.

FIG. 16 shows a manual variant for an actuation. Here, the cable pulley 43 is connected fixedly to the coupling linkage 44 so as to rotate with it. The toothing system 45 which is shown can be dispensed with in this exemplary embodiment. Moreover, a manual actuating lever 46 is provided which is mounted rotatably on the backrest strut 40. The actuating lever 46 bridges the coupling link, in particular the coupling linkage 44, in the case of the actuation from the top dead center, with the result that the backrest 3 can be folded over.

While specific embodiments of the invention have been shown and described in detail to illustrate the application of the principles of the invention, it will be understood that the invention may be embodied otherwise without departing from such principles.

1. A seat, comprising:
a seat part;
a backrest; and
a headrest, the backrest being pivotable via a backrest adjusting unit between a seat position and a folded-forward position, and the headrest being adjustable between a use position and a non-use position, by the backrest adjusting unit firstly opening a rotary fitting or a latching fitting of the backrest, and secondly adjusting the backrest between the seat position and the folded-forward position, and, in a case of pivoting of the backrest from the seat position into the folded-forward position, the headrest being set into the non-use position via an adjusting drive and, in a case of pivoting back of the backrest out of the folded-forward position into the seat position, the headrest being set into the use position via the adjusting drive, and the adjusting drive being coupled to the backrest adjusting unit.

2. The seat as claimed in claim 1, wherein the adjusting drive is a spring drive.

3. The seat as claimed in claim 2, wherein the spring drive is a compression spring.

4. The seat as claimed in claim 2, wherein the spring drive is a tension spring.

5. The seat as claimed in claim 1, wherein the backrest adjusting unit is operated electrically.

6. The seat as claimed in claim 1, wherein the backrest adjusting unit is operated manually.

7. The seat as claimed in claim 5, wherein the backrest adjusting unit is configured as a geared motor.

8. The seat as claimed in claim 6, wherein the backrest adjusting unit is configured as a coupler mechanism.

9. The seat as claimed in claim 1, wherein the adjusting drive and the backrest adjusting unit are coupled by a cable.

10. The seat as claimed in claim 9, wherein the cable is fastened on a headrest side to a headrest receptacle and on a backrest side to the backrest adjusting unit.

11. The seat as claimed in claim 1, wherein the adjusting drive is fastened on a headrest side to a headrest receptacle and on a backrest side to the backrest adjusting unit.

12. The seat as claimed in claim 1, wherein the adjusting drive is fastened on a headrest side to a headrest receptacle and on a backrest side in a fixed manner to a vehicle body.

13. The seat as claimed in claim 11, wherein the backrest comprises at least one retaining region and a loose region.

14. The seat as claimed in claim 13, wherein a headrest receptacle with one end, fastened thereto, of a cable and one end of the adjusting drive is configured be locked in a positively locking and/or non-positive manner in the at least one retaining region during adjusting of the headrest into a region of a use position.

15. The seat as claimed in claim 13, wherein a headrest receptacle with one end, fastened thereto, of a cable and one end of the adjusting drive is configured be locked in a positively locking and/or non-positive manner in the at least one retaining region, which is retained in a clamping manner, during adjusting of the headrest into a region of a use position.
